(19) United States
(12) Patent Application Publication
(10) Pub. No.: US 2006/0226673 A1
(43) Pub. Date: Oct. 12, 2006

(54) Combination floor extender and loading ramp

(76) Inventor: Richard Eugene Miller, Atlantic Beach, FL (US)

Correspondence Address: Richard Miller, 329 Ahern St. Apt. 3, Atlantic Beach, FL, 32233, US

(21) Appl. No.: 11/397,190

(22) Filed: Apr. 4, 2006

Related U.S. Application Data
(60) Provisional application No. 60/669,996, filed on Apr. 11, 2005.

(51) Int. Cl. B62D 25/00; B60P 1/00

(52) U.S. Cl. 296/61; 414/537; 296/26.09

(57) ABSTRACT

A slidably moving floor attachment for elongating the cargo area of a vehicle which may be further extended with the rear portion lowered to the ground forming a ramp. In the partially extended position the exposed floor is used to carry cargo while the unexposed portion contained in a housing is the weight bearing factor. This may be an aftermarket device attached to the top portion of a vehicle floor or built into the floor structure. The rearward extending floor panel used in a vehicle with dual horizontally hung doors in an open position may serve as the sides of the newly formed cargo area. A hinged rear gate attached to the rear portion of the floor panel and stowed in a locked position under the floor panel may swing to a vertical position and lock to the vehicles doors to form exterior walls of the newly formed cargo area.

### RELATED APPLICATIONS

This application claims priority to U.S. Provisional Application 60/669,996, filed Apr. 11, 2005, the entire contents of which are hereby incorporated by reference herein.

### BACKGROUND

1. Field of the Invention

The invention relates to a vehicle floor extender, extending the cargo carrying area of a vehicle in a first position and a loading ramp to facilitate the easy loading and unloading of a vehicle in a second position.

2. Background Description

Numerous devices have been developed which attach or enhance a truck or van cargo area A number of devices attach to pickup truck beds for the purpose of extending the cargo area or as aids in loading or unloading the cargo area. While these devices solve particular problems associated with extended cargo area, they all lack an ability to provide an attachment which not only provides additional cargo space, but also provides a ramp for easy loading of the cargo area.

Therefore there exist a need to provide a device which extends the standard cargo area and when not in use has a stowed position contained within the vehicle. This devise may quickly and easily be transformed into a loading ramp for loading and unloading a vehicle.

### SUMMARY OF THE INVENTION

It is accordingly an object of the present invention to provide an attachment unit for a vehicle which attaches to the floors of a vehicle and elongates the cargo area, and further a ramp to provide a device that is easily attached to the vehicle which can be unlatched, extended, and lowered to the ground for easy loading and unloading of the vehicle cargo area.

The invention may be an aftermarket unit or built into the vehicle floors. Vehicles having two cargo doors horizontally hinged to the vehicles body, may be used as side walls to the newly formed cargo area Using a rear gate hingedly attached to the rear portion of the floor panel, the rear gate may be moved to a vertical position and locked to the rear cargo doors forming the rear containment wall which may be in locked engagement with the rear cargo doors or unlocked for access to the cargo area. Having this arrangement will allow access from the sides or rear of the cargo area

### BRIEF DESCRIPTION OF THE DRAWINGS

FIG. 1 is a side view of a vehicle with a cutaway section showing the floor panel in a stowed position;

FIG. 2 is a side view of a vehicle with a cutaway section showing the floor panel in a first extended position with the rear hinged gate in a vertical position locked to the rear door of the vehicle; and

FIG. 3 is a side view of a vehicle with a cutaway section showing the floor panel completely extended with the rear portion lowered to the ground being used as a loading ramp.

### DETAILED DESCRIPTION OF THE PREFERRED EMBODIMENT

The preferred embodiment of the invention provides an apparatus for expanding the cargo area of a vehicle, and further a loading ramp for loading the vehicle. In a first active condition, the floor panel is partially extended for carrying cargo. The unextended portion of the floor panel will bear the weight of the extended portion, therefore the rear doors of the vehicle will not be a load bearing factor. The floor panel may have a hinged rear gate that in a vertical position will lock to the rear doors of the vehicle forming the rear and side walls of a newly formed cargo area. In a second active condition the floor panel is further extended and lower to the ground forming a loading ramp.

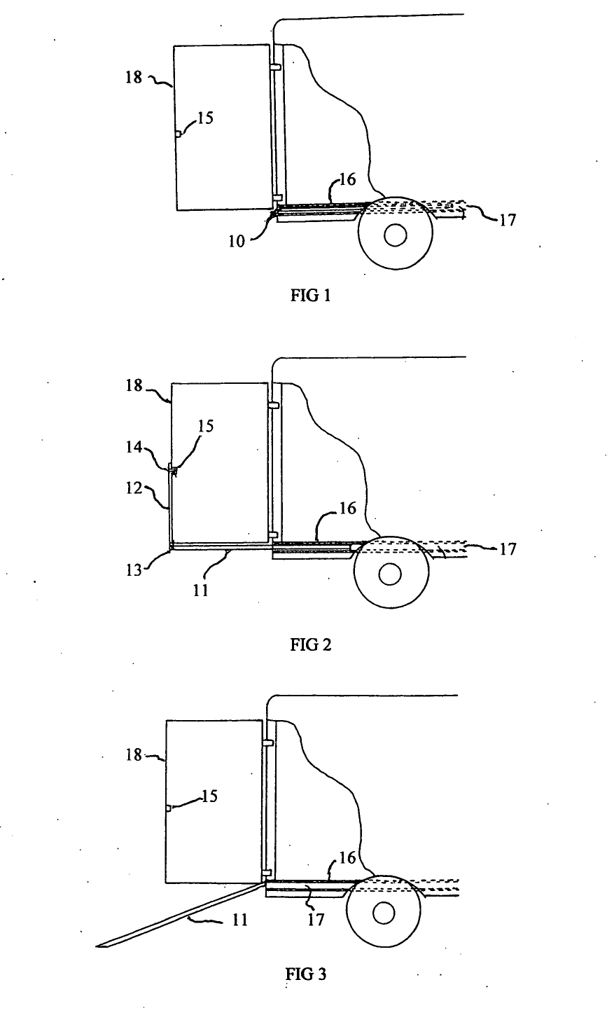

FIG. 1 shows a side view cutaway section of a vehicle with the extendable floor assembly 10 having the floor panel 11 in a stowed position inside of housing 17, located under floor 16 of the vehicle.

FIG. 2 shows a side view cutaway section of a vehicle with the floor panel 11 partially extended from housing 17 of the extendable floor assembly 10. In this position the floor panel 11, will shift the weight bearing factor to the rear unexposed portion of the floor panel 11 contained in housing 17 of the extendable floor assembly 10. In this position the floor extension is used to carry extra cargo in the expanded cargo area. The rear door 18 in an open position and the hinged rear gate 12 in a vertical position having the rear gate striker 14 in locked engagement with lock assembly 15 of doors 18 forming the rear and side walls of the newly formed cargo area.

FIG. 3 shows a side view cutaway section of a vehicle having the floor extension 11 fully extended from housing 17 of the extendable floor assembly 10 and the rear portion of the floor extension 11 lowered to the ground allowing the floor panel 11 to be used as a loading ramp.

The invention is not restricted to the illustrative examples described above. Examples are not intended as limitations on the scope of the invention. Methods, apparatus, compositions, and the like describe herein are exemplary and not intended as limitations on the scope of the invention. Changes therein and other uses will occur to those skilled in the art. The scope of the invention is defined by the scope of the claims.

What is claimed:

1. A extendable floor assembly or ramp mountable on a truck or van, said extendable floor assembly comprising:
a floor panel extending outward from a housing and a hinged rear gate in a vertical position forming a rear containment wall;
the floor panel being further extended beyond the rear cargo doors and the rear portion of said extendable floor panel being lowered to the ground forming a loading ramp.

2. A motor vehicle according to claim 1, wherein said rear hinged doors of a vehicle and said hinged rear gate of the floor panel in a vertical position are in locked engagement forming the rear and containment walls of the extended cargo area.

3. A vehicle according to claim 1, wherein said floor panel is slidably movable;

4. A vehicle according to claim 1, wherein said floor panel is hingedly movable;

5. A vehicle according to claim 1, wherein said floor panel has a front load bearing portion contained inside a housing and a partially extended rear portion usable for carrying cargo; and

6. A motor vehicle according to claim 1, wherein said hinged rear gate may be stowed under the floor panel in locked engagement with said floor panel.
